(19) United States
(12) Patent Application Publication
(10) Pub. No.: US 2009/0288004 A1
(43) Pub. Date: Nov. 19, 2009

(54) SYSTEM, METHOD, APPARATUS AND COMPUTER PROGRAM PRODUCT FOR PROVIDING A NOTIFICATION OF WIDGET AVAILABILITY

(76) Inventors: Toni Peter Strandell, Helsinki (FI); Ari Antero Aarnio, Espoo (FI); Carlos Miguel Quiroz Castro, Helsinki (FI); Seppo Juhani Pyhalammi, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/121,043

(22) Filed: May 15, 2008

(51) Int. Cl. G06F 3/00

(52) U.S. Cl. 715/710

(57) ABSTRACT

A method of providing a notification of widget availability may include receiving an indication of a visited location associated with a user, determining whether the visited location is associated with a widget on a device associated with the user, and providing a notification to the user of an availability of the widget for installation on the device based on the determining.

### TECHNOLOGICAL FIELD

Embodiments of the present invention relate generally to user interface technology and, more particularly, relate to a system, method, apparatus and computer program product for providing a notification mechanism, such as a notification mechanism regarding widget availability.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In many situations, it may be desirable for the user to interface with a device such as a mobile terminal for the provision of an application or service. As such, a user interface may be provided to enable receipt of user input at the device and provision of output to the user. The user interface may be utilized for text input, for selection of commands, options, hotspots, etc., for displaying information, rendering content and for numerous other functions. Accordingly, a typical user interface may include input devices such as a keyboard, mouse, microphone, or other like devices, and output devices such as a display, speaker, or other like devices. In some instances a touch screen display may be utilized to function as both an input and output device.

In some situations, elements of a user interface may be graphically displayed, e.g., in a graphical user interface (GUI) element, to enable a user to select certain functions. A widget is a small specialized GUI application that may provide visual information and/or easy access to frequently used functions such as clocks, calendars, news aggregators, calculators, desktop notes, etc. In this regard, for example, a widget may be considered a downloadable, interactive virtual tool (e.g., a software tool) that provides content such as headline news, exchange rates, sports results, stock quotes, weather forecasts, multilingual phrase dictionaries, encyclopedias, maps, entertainment listings, personal online calendars, or the like to a user. These kinds of widgets, which may also be referred to as desktop widgets are often hosted by a widget engine, which may be a software service configured to run and display widgets. Widgets tend to make user interface easier and more fulfilling for users since, for example, users can utilize widgets to tailor their own user experience to a large degree. Moreover, the widgets may be provided from a variety of services.

Widgets can be utilized on personal computers (PCs) or other computing platforms including mobile devices. Mobile widgets, which are widgets designed for use on mobile terminals, have been developed in order to operate in the unique environment of mobile electronic devices. As such, mobile widgets are often configured to optimize the use of limited screen space and other resources that may be in relatively short supply on mobile terminals.

Despite the utility provided by widgets, keeping one's widget portfolio up to date may be a challenging endeavor. For example, in order to add new or updated widgets, a user may typically be required to actively check for newly added widgets. Alternatively, if one starts using a new web page that may be a desirable target for a new widget, the user may be required to actively check a library or site that lists widgets to determine whether a widget is available for the new web page. Thus, maintaining one's widget portfolio may require a continued effort that average users may find cumbersome. Accordingly, usage of widgets (or at least new widgets) may decrease over time for many users.

Accordingly, it may be desirable to provide a mechanism for overcoming at least some of the disadvantages discussed above.

### BRIEF SUMMARY

A system, method, apparatus and computer program product are therefore provided to enable the provision of an improved mechanism for updating a widget portfolio. In this regard, embodiments of the present invention may provide for notifying users of available widgets for web pages of interest. As such, for example, if a particular user visits a website or web page, the user may be notified if one or more widgets are available for the visited website or web page or portion of a page (e.g., a feed indicating that a page “behind” or associated with the feed has a new widget available.

Embodiments of the invention may provide a system, method, apparatus and computer program product for advantageous employment in both mobile and fixed environments. As a result, for example, mobile terminal users may enjoy an improved user interface capability and a corresponding improved user experience.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic block diagram of an apparatus for providing a notification of widget availability according to an exemplary embodiment of the present invention;

FIG. 4 illustrates an exemplary architecture for a system for providing a notification with regard to widget availability in accordance with an exemplary embodiment of the present invention;

FIG. 5 illustrates an exemplary web page employing an embodiment of the present invention;

FIG. 6 illustrates an exemplary widget profile showing an inclusion of a newly installed widget within the widget profile; and

FIG. 7 is a flowchart according to an exemplary method for providing a notification of widget availability according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

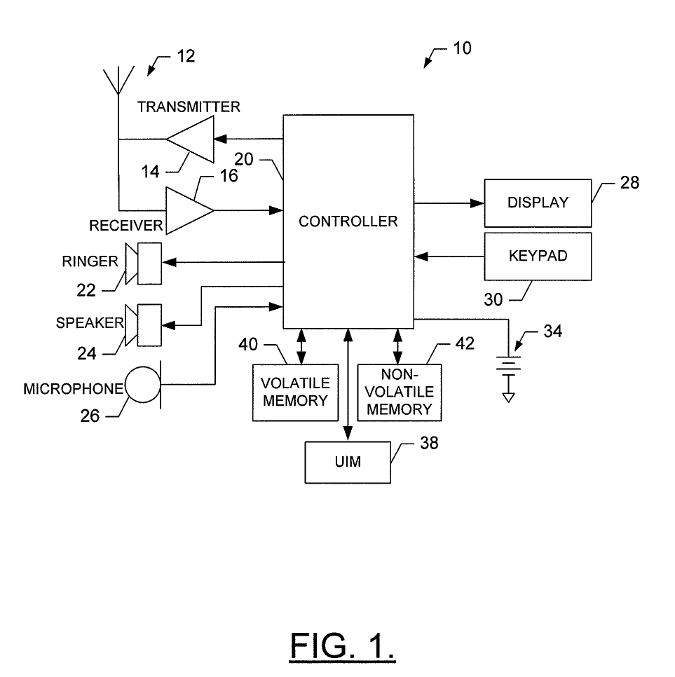

FIG. 1, one exemplary embodiment of the invention, illustrates a block diagram of a mobile terminal 10 that may benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, all types of computers, cameras, video recorders, audio/video player, radio, GPS devices, tablets, internet capable devices, or any combination of the aforementioned, and other types of communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

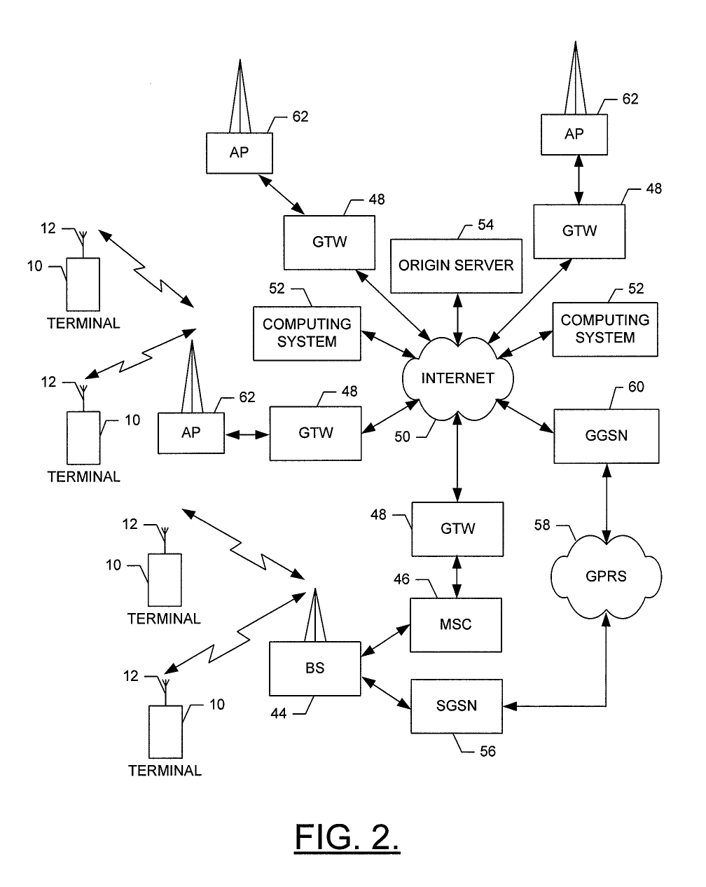

The mobile terminal 10 includes an antenna 12 (or multiple antennas) in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA)), with 3.9G wireless communication protocol such as E-UTRAN (Evolved UMTS Terrestrial Radio Access Network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus such as the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content, data or information sharing) between the mobile terminal 10 and other mobile terminals or network devices. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a mobile telephone, mobile computer, gaming device, camera, computer or other device, absent any communication with the system of FIG. 2.

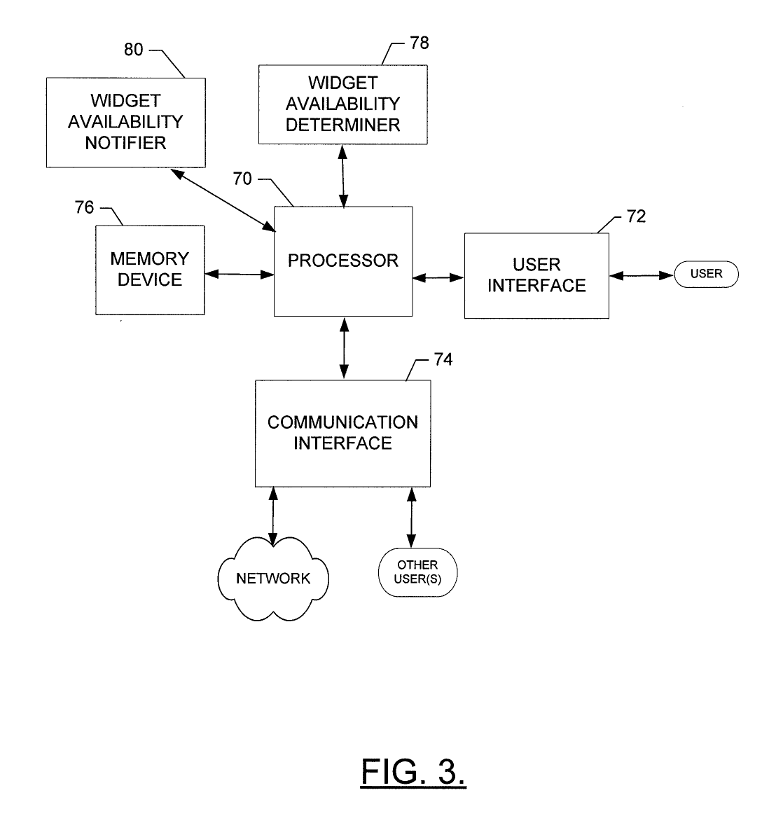

An exemplary embodiment of the invention will now be described with reference to FIG. 3, in which certain elements of an apparatus for providing a notification of widget availability are displayed. The apparatus of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. Alternatively, embodiments may be employed on a combination of devices including, for example, those listed above. Accordingly, embodiments of the present invention may be embodied wholly at a single device (e.g., the mobile terminal 10) or by devices in a client/server relationship. Furthermore, it should be noted that the devices or elements described below may not be mandatory and thus some may be omitted in certain embodiments.

In the context of the description below, a widget should be understood as being, for example, a desktop widget, a mobile widget, an application or software component that may operate in the context of another program (e.g., a browser) to perform a function, or the like. In an exemplary embodiment, a widget could generally be configured with, for example, any feed such as an RSS feed, other feeds, utility widgets, etc. Thus, any web site with RSS fees links could potentially be associated with a widget. As such, embodiments of the present invention may be utilized on either mobile or fixed platforms (or a combination thereof). Moreover, as will be seen below, in one exemplary embodiment, a user at a fixed platform such as a PC may be made aware of the availability of mobile widgets associated with a particular visited website and the user may select one or more available mobile widgets for download and storage at a mobile terminal that may be associated with the user. Similarly, a mobile user could designate widgets for download and storage at a PC associated with the mobile user. Thus, the user may designate widgets for download and storage at a device that is remote from (e.g., a different device than) the device from which the designation for downloading is provided. These and other features may be accomplished via the exemplary apparatus described below in reference to FIG. 3, which illustrates one example of an architecture for an exemplary embodiment of the present invention. However, it should be understood that embodiments could also employ other alternative architectures.

Referring now to FIG. 3, an apparatus for providing a word input mechanism is provided. The apparatus may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit) or an FPGA (field programmable gate array). In an exemplary embodiment, the processor 70 may be configured to execute instructions stored in the memory device 76 or otherwise accessible to the processor 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a mobile terminal (e.g., the mobile terminal 10), the user interface 72 may include, among other devices or elements, any or all of the speaker 24, the ringer 22, the microphone 26, the display 28, and the keyboard 30.

In an exemplary embodiment, the processor 70 may be embodied as, include or otherwise control a widget availability determiner 78 and/or a widget availability notifier 80. The widget availability determiner 78 and the widget availability notifier 80 may each be any means such as a device or circuitry embodied in hardware, software or a combination of hardware and software that is configured to perform the corresponding functions of the widget availability determiner 78 and the widget availability notifier 80, respectively, as described below.

In this regard, the widget availability determiner 78 may be configured to enable the apparatus to determine whether a currently visited site has an available widget associated therewith. An “available widget” as referred to herein may mean a widget that can be installed in which the widget may be associated with the site currently being visited. The available widget may simply be a widget associated with a site; however, the available widget could alternatively be a widget that is a widget that is associated with the site, but also not installed on a particular device associated with the user or a widget that is associated with the site and is an updated version of a widget that is already installed on a device of the user. In an exemplary embodiment, the available widget could be a widget that is recommended by another entity. For example, other visitors to a particular website or of a particular widget may recommend the widget or otherwise provide the widget with a favorable rating. In an exemplary embodiment, if the widget associated with a particular website is recommended by or given a favorable rating by a threshold number of visitors to the website, any subsequent visitor to the website may receive an indication of an available widget with respect to the widget associated with the website. As an alternative, recommendations from trusted parties or individuals in a contact or friend list may be used to generate indications of available widgets on a personal level for a user whose friends have recommended a particular website. As such, for example, the widget availability determiner 78 of one exemplary embodiment may be configured to receive information indicative of a visited site (e.g., a website or web page that is currently being viewed by a browser of a user's device), such as a web address, and determine, for the address associated with the visited site, whether one or more widgets (e.g., available widgets) are available for download and/or installation in association with the visited site.

In an exemplary embodiment, a component in a web browser or browser plugin of the user's device (e.g., the mobile terminal 10 or a PC) may provide information on the visited site (e.g., web page address, keywords extracted from the HTML code of a web page, links, feeds (e.g., RSS (really simple syndication format) or ATOM (atom syndication format)), or the like) to identify the visited site to the widget availability determiner 78 for use by the widget availability determiner 78 in accessing information regarding widget availability for the visited site. In an exemplary embodiment, the widget availability determiner 78 may be configured to access information regarding widget availability by searching existing widgets (e.g., in a widget library) for widgets associated with the visited site as identified based on the provided information on the visited site. The associated widgets may be considered widgets available for download to a device associated with the user. In some embodiments, the widget availability determiner 78 may be further configured to determine which of the widgets that are considered to be available for download to the device of the user are not currently stored on or in association with the device associated with the user. As such, for example, if a particular site is visited and the visited site has two associated widgets, only one of the widgets may be indicated as being an available widget if the other widget is already stored in association with the device of the user.

In an exemplary embodiment, the apparatus of FIG. 3 may be embodied at a network device (e.g., a server) in communication with the device of the user (e.g., the mobile terminal 10 or a PC of the user). As such, for example, the information indicative of a visited site may be communicated to the widget availability determiner 78 via the network and the communication interface 74. In such situations, the device of the user (e.g., the mobile terminal 10 or the PC) may include a browser plugin or modified browser that is configured to be aware of the user's widget credentials or portfolio. In other words, the browser or plugin may be configured to know which widgets the mobile terminal 10 or PC currently has stored therein or in a location accessible thereto. In the context of some embodiments of the present invention, a browser may be considered as any application that can read content or information of any kind that, in at least one embodiment, may be presented for display. Upon entering a particular website, the browser or plugin may communicate with the widget availability determiner 78 on the network device via the network and the communication interface 74 and/or communicate with a widget library to check a listing of available widgets for the visited site against the widgets already installed for the user's device to determine whether any new widgets relative to those already installed for the user's device are available. An identification of the new widgets that are available may then be provided to the browser or plugin for further notifying the user of the availability (e.g., via the widget availability notifier 80). A new widget could also simply be a new version of an old widget that is already installed on the user's device.

In an alternative exemplary embodiment, the apparatus of FIG. 3 may be embodied at the mobile terminal 10 or PC of the user (e.g., the user's device). As such, for example, the information indicative of a visited site may be determined by the widget availability determiner 78 itself, or communicated internally to the widget availability determiner 78. In such situations, the device of the user (e.g., the mobile terminal 10 or the PC) may include a browser plugin or modified browser, either of which may be embodied as the widget availability determiner 78. Alternatively, the widget availability determiner 78 may be a portion of the browser or plugin. In any case, the widget availability determiner 78 may be configured to be aware of the user's widget credentials or portfolio as described above. Upon entering a particular website, the widget availability determiner 78 may communicate with a widget server or widget library on a network device via the network and the communication interface 74 to check a listing of available widgets for the visited site against the widgets already installed for the user's device to determine whether any new widgets relative to widgets already installed on the user's device are available. An identification of the new widgets that are available may then be provided to the browser or plugin for further notifying the user of the availability (e.g., via the widget availability notifier 80).

As an alternative to the embodiments described above in which the apparatus of FIG. 3 is embodied at a network device or at a device of the user (e.g., the mobile terminal 10 or a PC of the user), portions of the apparatus may be split between a network device and the device of the user.

As indicated above, in one exemplary embodiment, one device associated with the user may be utilized to check the availability of new widgets with respect to another device associated with the user. As such, for example, the user may use a PC employing the apparatus of FIG. 3 or at least portions thereof (e.g., including the widget availability determiner 78) to determine whether new widgets relative to the user's mobile terminal 10 are available. The apparatus may then be employed (e.g., via the widget availability notifier 80) to enable the user to select one or more new widgets for installation such as by download to and/or storage in association with the mobile terminal 10. Since, as described above, a new widget could also be a new or updated version of an old widget that is already installed on the user's device, embodiments of the present invention may be used to indicate updates to existing or currently installed widgets. In some embodiments, the widget availability notifier 80 may indicate whether an available widget is an updated version of a widget already installed on a device or a widget that is not installed on the device and is not an updated version of a widget installed on the device.

The widget availability notifier 80 may be configured to notify the user (e.g., via the user interface 72) of the availability of widgets associated with the visited site. In an exemplary embodiment, the widget availability notifier 80 may alternatively provide information related to content within a widget. As such, for example, the widget availability notifier 80 may be configured to receive information from the widget availability determiner 78 indicative of the available widgets associated with the visited site. In some embodiments, the information indicative of the available widgets may include only those widgets that are new relative to the user's device upon which the widgets could be employed. In other words, the widget availability determiner 78 may filter out widgets that, although associated with the visited site and available for use at the device of the user, are already stored in association with the device of the user and installed thereon. However, in alternative embodiments, the widget availability determiner 78 may provide a complete listing of available widgets to the widget availability notifier 80.

Furthermore, although the widget availability notifier 80 may inform a user at one device of widgets available for installation on another device, the widget availability notifier 80 may also be able to consider the availability of widgets for numerous devices associated with a particular user. In this regard, for example, a user profile may be maintained that may indicate, for each of several devices, which widgets are installed on each respective device. Accordingly, when the widget availability determiner 78 operates to determine which widgets are available for each respective device associated with the user for a visited site, the widget availability determiner 78 may check a single widget library for each widget associated with the visited site and filter information provided to the widget availability notifier 80 based on which widgets are already installed on various ones of the devices associated with the user. The widget availability notifier 80 may then notify the user of the widgets available and, in some cases, which of the widgets are available for respective devices. In this regard, for example, the widget availability notifier 80 may provide an icon or other graphical indicator to indicate that one or more widgets are available and, in response to user selection of the icon or graphical indicator, the user may be provided with specific information identifying which widgets are available for which corresponding devices. Alternatively, the icon or graphical indicator may be device specific.

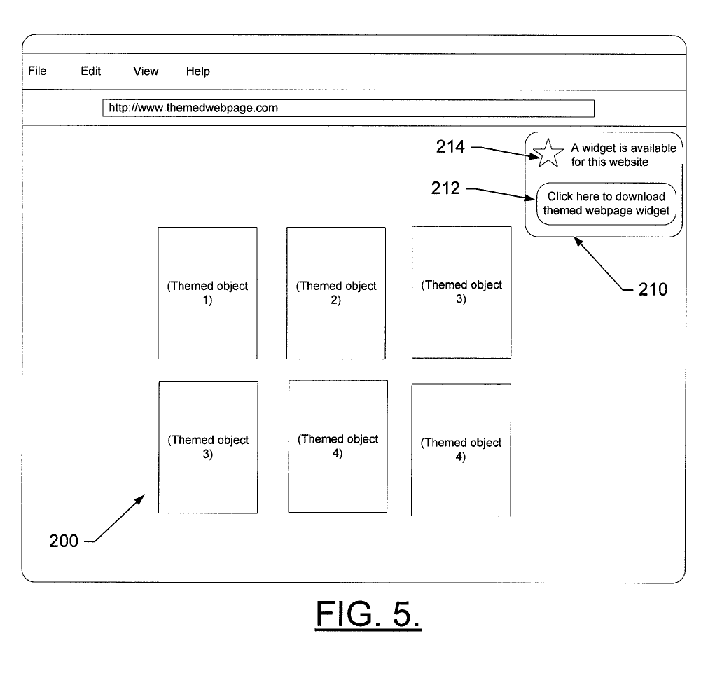

Accordingly, after receiving the information indicative of the available widgets (either including all available widgets or only the new available widgets) the widget availability notifier 80 may be configured to inform the user of the available widgets. In an exemplary embodiment, the widget availability notifier 80 may provide a notification (e.g., see element 210 of FIG. 5) to the user with regard to the availability of widgets. In this regard, the notification could be accomplished in numerous ways. In some embodiments, an icon or other graphic may be generated for display to indicate to the user that widgets are available. Alternatively, a popup window or other interface control console may be provided. In response to selection of the icon or graphic, or via the popup window or interface control console, the user may be provided with an identification or listing of the available widgets. One or more of the available widgets may then be selected by the user to trigger download and/or storage of the selected widget(s) to a device of the user (which may be the device used to make the selection or another device). In some instances, the notification may itself be an identification of a widget available for installation. In an exemplary embodiment, a widget selected for installation may be configured for the particular user (e.g., based on credentials, cookies, preferences or the like) during or prior to installation. Furthermore, in some embodiments, a context of the location visited may be used or considered with respect to configuring a widget selected for installation. For example, if a particular page associated with viewing images or other specific content is being visited when a widget is selected for download and has a corresponding particular design or tag associated therewith, the widget may be automatically configured to incorporate features such as the design or tag.

Thus, the widget availability notifier 80 may be configured to generate a notification to be displayed to the user if a widget is available. Selection of the notification may enable the user to select one or more of the available widgets for storage in association with a device associated with the user. In some embodiments, the widget availability notifier 80 may be configured to generate controls for enabling the user to install a selected widget among those indicated as being available. As such, the widget availability notifier 80 may be configured to receive the user selection and provide for widget download and/or storage accordingly. In this regard, for example, when a user selection is made (e.g., via the user interface 72), the selection may be communicated to the widget availability notifier 80, which may be configured to provide information to a server or device storing the selected widget to initiate installation of the widget at a device of the user. Thus, for example, the widget availability notifier 80 may be configured to provide interface elements for notifying the user of the availability of widgets and also to respond to user selection of a widget to initiate downloading of the selected widget to a device associated with the user.

In embodiments where the device to which the widget is to be provided is in communication with the server or location where the widget is stored, the installation of the widget may be conducted automatically and without user input. However, if there is no active connection between the server or location where the widget is stored and the device to which the widget is to be provided, then the widget may be installed when the next connection is made. In some embodiments, the listing of widgets may be decentralized and the browser or plugin may get an identification or listing of other servers to which a connection may be made in order to access particular widgets from the list or to access the list of widgets itself. In another exemplary embodiment, the browser or plugin may periodically query a widget server or library in order to cache information regarding available widgets in memory. Thus, a device employing such an embodiment may check widget availability locally, which may reduce a number of HTTP requests used to check availability of widgets for a given page.

Accordingly, according to an exemplary embodiment of the present invention, notification to a user of available widgets may be provided in the context of a viewed or visited web page. Thus, if there is an available widget for the currently visited or viewed web page, the notification is provided or activated and otherwise the notification is not visible to the user. The notification works in the context of any particular web page and does not require changes to the web page.

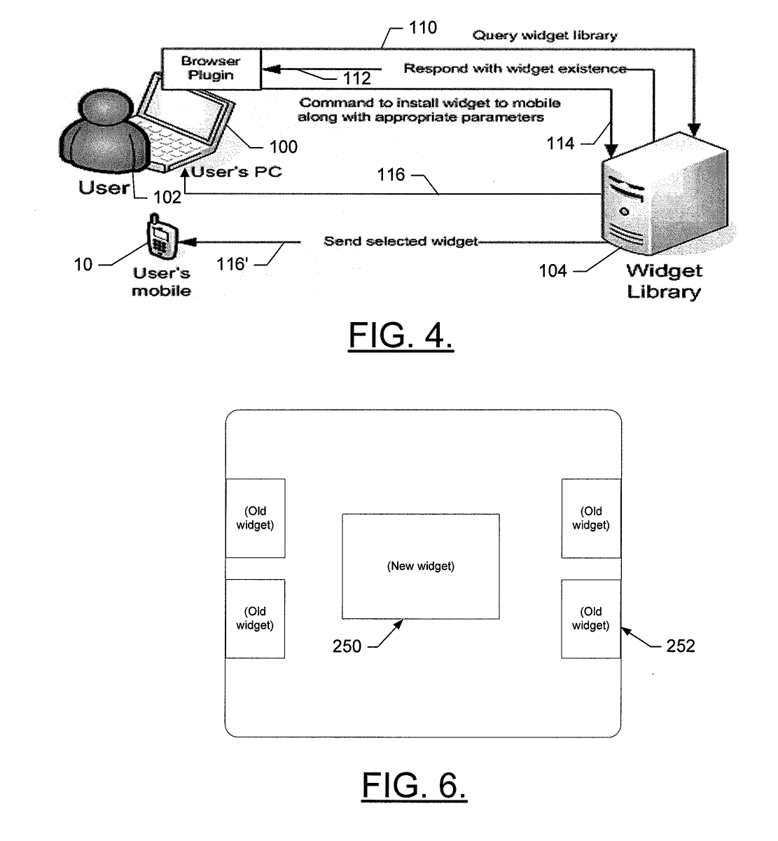

FIG. 4 illustrates an exemplary architecture for a system for providing a notification with regard to widget availability in accordance with an exemplary embodiment. In this regard, as shown in FIG. 4, the system may include a PC 100 associated with a user 102. The system may also include a widget library 104 and a mobile terminal 10 associated with the user. The widget library 104 may be embodied as a server (e.g., an exemplary server as described above in reference to FIG. 3) including information indicating widget availability, for example, on a website by website basis. In a first operation 110, a browser plugin at the PC 100 may query the widget library 104 with regard to the availability of widgets for a site visited by the PC 100. The widget library 104 may respond to the PC 100 with an indication of widget availability at operation 112. The PC 100 may then provide a command to the widget library 104 to install a selected widget on a device associated with the user 102 (e.g., either the PC 100 or the mobile terminal 10) at operation 114. At operation 116, the widget library 104 may install the selected widget to the PC 100. Alternatively, at operation 116′, the widget library 104 may install the selected widget to the mobile terminal 10 if the PC 100 instead identified the mobile terminal 10 as the target device onto which the widget (e.g., a mobile widget) is to be installed. Notably, roles of the PC 100 and the mobile terminal 10 could also be reversed in an exemplary embodiment.

In an exemplary embodiment, the widget library 104 may be in communication with a WidSets service server. Using a WidSets service, the user can provide favorite content directly to the user's mobile terminal. The user can also share preferred content with other users or publish content to the web. In the WidSets service, the user can register the user's device select widgets from, for example, a dashboard on the device. The WidSets service server may be connected to respective URLs and, if a change is made to a URL or information associated therewith, an indication of the change may be provided to the user via the dashboard. In some embodiments, the WidSets service server may have or be provided with knowledge of existing widgets. Thus, if the user requests a widget associated with a particular URL, the widget can be added to the dashboard, for example, by linking user information (e.g., an account number) and the request. When the user's device gets a subsequent update to the dashboard, the URL associated with the particular URL may be synchronized with the service server and the widget can be shown on the device's display. If the widget does not exist, the WidSets service server may have a record of one or more URLs requests for which the user has intended to generate and create a widget. In one embodiment, the server may inquire as to whether the user would like to create a widget. If the user indicates a desire to create a widget, the widget may be loaded onto the dashboard.

FIG. 5 illustrates an exemplary web page employing an exemplary embodiment of the present invention. More specifically, FIG. 5 illustrates a web page with themed content associated with content items 200. As shown in FIG. 5, a notification 210 may be provided to indicate that a widget associated with the web page is available or indicate information related to the content of a widget. The notification 210 may include or be embodied as an icon 214. However, numerous other examples of user interface elements may be used for providing the notification 210. For example, a widget icon could be provided in a browser address bar or system tray icon could be provided to be activated when a widget is available. A control 212 may also be provided as a portion of or in association with the notification 210. Selection of the control 212 may initiate installation of the corresponding widget. After installation of the corresponding widget, an object indicative of the corresponding widget may be added to the widget profile of the device to which the widget was installed as shown in FIG. 6. FIG. 6 shows a display of a new widget 250 among a plurality of old widgets 252.

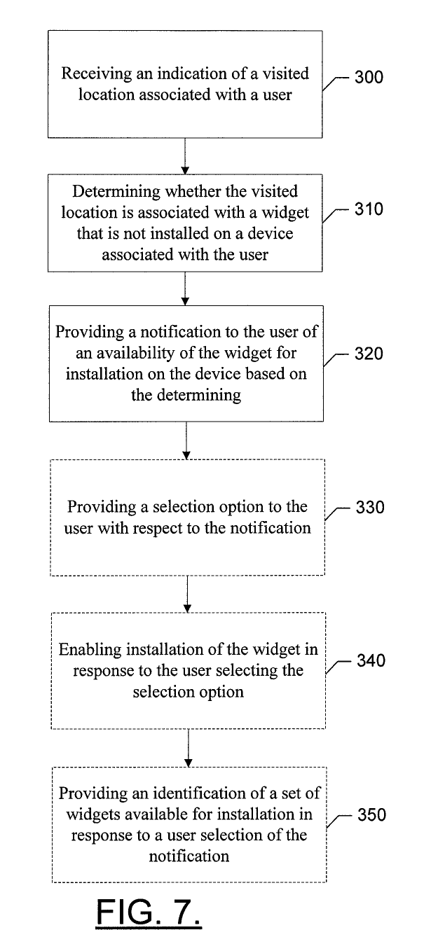

FIG. 7 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing a notification of widget availability as illustrated, for example, in FIG. 7 may include receiving an indication of a visited site or location associated with or currently being visited by a user at operation 300. The method may further include determining whether the visited location is associated with a widget on a device associated with the user at operation 310 and providing a notification to the user of an availability of the widget for installation on the device based on the determining at operation 320. In an exemplary embodiment, operation 310 may include determining whether the visited location is associated with a widget that is not installed on the device associated with the user. In this regard, the widget may be a new widget or an updated version of a widget already installed on the device. As such, in the context of some embodiments, an updated version of an existing widget may be considered to be a widget that is not installed on the device.

In some embodiments, the method may include further optional operations some examples of which are shown in dotted lines in FIG. 7. For example, the method may further include providing a selection option to the user with respect to the notification at operation 330. The selection option may enable the user to select the widget for installation at the device associated with the user. In an exemplary embodiment, the method may further include enabling installation of the widget in response to the user selecting the selection option at operation 340 or providing an identification of a set of widgets available for installation in response to a user selection of the notification at operation 350. As indicated above, a widget selected for installation may further be configured to be tailored to the particular user requesting the installation.

In an exemplary embodiment, receiving an indication of the visited location may include receiving the indication from a device other than the device associated with the user to which the notification is provided. Meanwhile, providing the notification may include providing a notification of widget availability with respect to a plurality of user devices associated with the user. In an exemplary embodiment, determining whether the visited location is associated with the widget may include referencing a widget library for widgets within the library that are associated with the visited location. In some embodiments, determining whether the visited location is associated with the widget that is not installed on the device associated with the user may include comparing a set of widgets within the library that are associated with the visited location with a set of widgets already installed on the device or determining whether the visited location is associated with an updated version of a widget previously installed on a device associated with the user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a visited location associated with a user;
determining whether the visited location is associated with a widget on a device associated with the user; and
providing a notification to the user of an availability of the widget for installation on the device based on the determining.

2. A method according to claim 1, further comprising providing a selection option to the user with respect to the notification, the selection option enabling the user to select the widget for installation at the device associated with the user.

3. A method according to claim 2, further comprising enabling installation of the widget in response to the user selecting the selection option.

4. A method according to claim 2, further comprising providing an identification of a set of widgets available for installation in response to a user selection of the notification.

5. A method according to claim 1, wherein receiving an indication of the visited location comprises receiving the indication from a device other than the device associated with the user to which the notification is provided.

6. A method according to claim 1, wherein providing the notification comprises providing a notification of widget availability with respect to a plurality of user devices associated with the user.

7. A method according to claim 1, wherein determining whether the visited location is associated with the widget comprises referencing a widget library for widgets within the library that are associated with the visited location.

8. A method according to claim 1, wherein determining whether the visited location is associated with the widget on the device associated with the user comprises comparing a set of widgets within the library that are associated with the visited location with a set of widgets already installed on the device.

9. A method according to claim 1, wherein determining whether the visited location is associated with the widget on a device associated with the user comprises determining whether the visited location is associated with an updated version of a widget previously installed on a device associated with the user.

10. An apparatus comprising a processor configured to:
receive an indication of a visited location associated with a user;
determine whether the visited location is associated with a widget on a device associated with the user; and
provide a notification to the user of an availability of the widget for installation on the device based on the determining.

11. An apparatus according to claim 10, wherein the processor is further configured to provide a selection option to the user with respect to the notification, the selection option enabling the user to select the widget for installation at the device associated with the user.

12. An apparatus according to claim 11, wherein the processor is further configured to enable installation of the widget in response to the user selecting the selection option.

13. An apparatus according to claim 11, wherein the processor is further configured to provide an identification of a set of widgets available for installation in response to a user selection of the notification.

14. An apparatus according to claim 10, wherein the processor is configured to receive an indication of the visited location by receiving the indication from a device other than the device associated with the user to which the notification is provided.

15. An apparatus according to claim 10, wherein the processor is configured to provide the notification by providing a notification of widget availability with respect to a plurality of user devices associated with the user.

16. An apparatus according to claim 10, wherein the processor is configured to determine whether the visited location is associated with the widget by referencing a widget library for widgets within the library that are associated with the visited location.

17. An apparatus according to claim 10, wherein the processor is configured to determine whether the visited location is associated with the widget on the device associated with the user by comparing a set of widgets within the library that are associated with the visited location with a set of widgets already installed on the device.

18. An apparatus according to claim 10, wherein the processor is configured to determine whether the visited location is associated with the widget on a device associated with the user by determining whether the visited location is associated with an updated version of a widget previously installed on a device associated with the user.

19. A computer program product comprising at least one computer-readable storage medium having computer-executable program code portions stored therein, the computer-executable program code portions comprising:
a first program code portion for receiving an indication of a visited location associated with a user;
a second program code portion for determining whether the visited location is associated with a widget on a device associated with the user; and
a third program code portion for providing a notification to the user of an availability of the widget for installation on the device based on the determining.

20. A computer program product according to claim 19, further comprising a fourth program code portion for providing a selection option to the user with respect to the notification, the selection option enabling the user to select the widget for installation at the device associated with the user.

21. A computer program product according to claim 20, further comprising a fifth program code portion for enabling installation of the widget in response to the user selecting the selection option.

22. A computer program product according to claim 20, further comprising a fifth program code portion for providing an identification of a set of widgets available for installation in response to a user selection of the notification.

23. A computer program product according to claim 19, wherein the first program code portion includes instructions for receiving the indication from a device other than the device associated with the user to which the notification is provided.

24. A computer program product according to claim 19, wherein the third program code portion includes instructions for providing a notification of widget availability with respect to a plurality of user devices associated with the user.

25. A computer program product according to claim 19, wherein the second program code portion includes instructions for referencing a widget library for widgets within the library that are associated with the visited location.

26. A computer program product according to claim 19, wherein the second program code portion includes instructions for comparing a set of widgets within the library that are associated with the visited location with a set of widgets already installed on the device.

27. A computer program product according to claim 19, wherein the second program code portion includes instructions for determining whether the visited location is associated with an updated version of a widget previously installed on a device associated with the user.

28. A system comprising:
a widget availability determiner configured to receive an indication of a visited location associated with a user and determine whether the visited location is associated with a widget on a device associated with the user; and
a widget availability notifier configured to provide a notification to the user of an availability of the widget for installation on the device based on the determining.

29. A system according to claim 28, wherein the widget availability notifier is further configured to provide a selection option to the user with respect to the notification, the selection option enabling the user to select the widget for installation at the device associated with the user.

30. A system according to claim 28, wherein the widget availability determiner and the widget availability notifier are each embodied at a server device in communication with the device associated with the user.

31. A system according to claim 28, wherein the widget availability determiner and the widget availability notifier are each embodied at a client device associated with the user.

32. A system according to claim 31, wherein receiving the indication of the visited location comprises receiving the indication from the client device and wherein the client device is different than the device associated with the user to which the notification is provided.

33. A system according to claim 28, further comprising a widget library and wherein the widget availability determiner is configured to determine whether the visited location is associated with the widget by referencing the widget library for widgets within the library that are associated with the visited location.
